(19) United States
(12) Patent Application Publication
(10) Pub. No.: US 2015/0369290 A1
(43) Pub. Date: Dec. 24, 2015

(54) BEARING CAGE FOR A ROLLING-ELEMENT BEARING, IN PARTICULAR FOR A TAPERED ROLLER BEARING

(71) Applicants: Rico Dittmar, Schweinfurt (DE); Volker Wendt, Uchtelhausen Zell (DE)

(72) Inventors: Rico Dittmar, Schweinfurt (DE); Volker Wendt, Uchtelhausen Zell (DE)

(73) Assignee: Aktiebolaget SKF, Goteborg (SE)

(21) Appl. No.: 14/748,752

(22) Filed: Jun. 24, 2015

(30) Foreign Application Priority Data
Jun. 24, 2014 (DE) 102014212076.4

(51) Int. Cl. F16C 33/46; F16C 19/36

(52) U.S. Cl. CPC F16C 33/4682; F16C 19/364

(57) ABSTRACT

A bearing cage for a tapered rolling-element bearing includes at least one first ring element and at least one second ring element connected to the at least one first ring element via at least one bridge. The first ring element and the second ring element are configured to receive at least one rolling element between them and to retain the rolling element axially, the bridge is configured to retain the at least one rolling element circumferentially, and the at least one first ring element includes a flange extending at least partially radially outward beyond a radially outer surface of the at least one bridge.

### CROSS-REFERENCE

This application claims priority to German patent application no. 10 2014 212 076.4 filed on Jun. 24, 2014, the contents of which are fully incorporated herein by reference.

### TECHNOLOGICAL FIELD

The present disclosure relates to a bearing cage for a rolling-element bearing, in particular for a tapered roller bearing. The bearing cage includes at least one first ring element and one second ring element that are connected to each other via at least one bridge. The first and second ring elements are configured to receive at least one rolling element between them and to hold the at least one rolling element axially, and the at least one bridge is designed to hold the at least one rolling element circumferentially.

### BACKGROUND

Rolling-element bearings, in particular tapered roller bearings, usually include a bearing outer ring and a bearing inner ring. Rolling elements are disposed between these rings to permit relative movement between the outer ring and the inner ring. The rolling-element bearing can be a full-complement bearing, that is, a bearing in which the rolling elements contact one another directly, or the bearing may include a bearing cage that axially and circumferentially secures and separates the rolling elements. Advantageously, bearing cages can simplify the assembly of a rolling-element bearing.

The rolling elements themselves can be, for example, spherical, cylindrical, toroidal, or conical. Rolling-element bearings that include conical rolling elements, so-called tapered roller bearings, also have a retaining flange and a guide flange attached to the inner ring or to the outer ring to help axially stabilize the rolling elements.

In order to reduce friction between the elements of a rolling-element bearing that are movable against one another, it is further known to provide a lubricant in the rolling-element bearing. Especially in tapered roller bearings such a lubricant helpfully reduces the friction produced by the rolling elements rubbing against the retaining flange or guide flange.

However a problem with such tapered roller bearings is that the lubricant is transported by the tapered rollers from their smaller diameter ends towards their larger diameter ends, and from there transported out of the bearing. The lubricant thereafter collects in static regions and is no longer available for lubricating the rolling elements.

It will be appreciated that, starting at a certain distance from the rolling elements, the force with which the lubricant adheres to the static parts of the bearing is greater than the shear force of the lubricant. Therefore, the lubricant can only be removed from the static regions by a particularly high operating temperature or by a physical shock. This can disadvantageously lead to too little lubricant or no lubricant at all being available on the rolling elements, in particular in the region of the retaining flange, leading to insufficient lubrication in these locations. This insufficient lubrication in turn leads to an undesirable temperature increase and thus also to excessive wear and a reduced service life of the rolling-element bearing elements.

### SUMMARY

The object of the present disclosure is therefore to provide a rolling-element bearing, in particular a tapered roller bearing, which provides an improved lubricant retention.

According to the disclosure, a bearing cage for a rolling-element bearing, in particular for a tapered roller bearing, is provided, which includes at least a first ring element and a second ring element connected to one another via at least one bridge. The first and the second ring elements are configured to receive at least one rolling element between them and to hold the at least one rolling element axially, while the at least one bridge is configured to hold the rolling element circumferentially and to space it from an adjacent rolling element. Bearing cages of this type are usually configured such that pairs of adjacent bridges form a receiving pocket for a rolling element, and the pocket has a circumferential width between the adjacent bridges and an axial length between the ring elements.

In order to improve lubricant retention in the rolling-element bearing, the disclosed bearing cage includes a flange on at least the first ring element, which flange extends at least partially radially outward over (when the rolling element bearing is oriented with the first ring element above the second ring element) or beyond a radially outer surface of the bridge. This radially-outward-extending flange also defines a volume for the lubricant in a further spacing from a rolling-element end side, in which volume the lubricant is retained and impeded from being pumped outwardly. In a rolling-element bearing provided with such a bearing cage, the lubricant can thereby be retained on the rolling elements, and the amount of lubricant that comes to rest in static regions is reduced. It is particularly advantageous if the flange extends only radially outward but not radially inward, so that its radially inner side extends up to a radially inner surface of the bridge because such a configuration does not impede access of the lubricant to the rolling elements.

Advantageously, the flange may extend radially outward from a location axially outside the outer ring of the rolling-element bearing. In this case, the outer ring can be made to be axially shorter than a conventional outer ring.

According to a further advantageous exemplary embodiment the flange and the ring element are integrally formed. This is particularly advantageous if the cage is injection-molded from a material, in particular plastic, since then the inventive flange and the cage can be formed in one work step.

According to a further advantageous exemplary embodiment the flange and the ring element are formed separately. In this case the flange in particular can be attachable or connected in the course of assembly by interference-fit or by friction-fit or by welding or by snap-fit, to the ring element. This is particularly advantageous if pre-existing cages are to be fitted with the flange disclosed herein.

According to a further advantageous exemplary embodiment the flange may project into the inner region of the cage to improve lubricant retention in this location as well. Particularly in the plugged-on design of the flange this radially-inward extension can be formed simply by the plug-on edge. However, an inwardly-extending flange is also possible, of course, in the integral design.

According to a further advantageous exemplary embodiment the bearing cage includes at least one recess or opening between the flange and the ring element. This recess allows lubricant located in the outer region of the bearing cage, in particular in the vicinity of the outer ring of the bearing, to be pumped back towards the rolling elements, and in particular towards the bearing inner ring. Particularly good lubrication of the critical regions can thereby be ensured, particularly in the region of the retaining flange and/or of the guide flange.

It is particularly advantageous if the recess is located in the region of the to-be-received rolling elements. In this way lubricant can be guided back directly onto the rolling elements and via the rolling elements directly onto the points to be lubricated.

According to a further advantageous exemplary embodiment the first ring element has a first radius and the second ring element has a second radius, the first radius being larger than the second radius. Since this disclosed bearing cage may advantageously be used in tapered roller bearings that usually have ring elements with first and second different radiuses, and the lubrication problem primarily occurs on the ring element having the larger diameter, it would be sufficient to only provide the disclosed flange on the larger ring element. Materials and thus costs can thereby be saved. Of course it is possible to form an inventive flange on the smaller ring element, so that an innovative lubricant management can also be provided in this region.

According to a further advantageous exemplary embodiment the bearing cage is assembled from bearing cage segments, each bearing cage segment including at least one bridge and a first and a second ring-element segment. A flange as described herein can be disposed on at least one of the ring element segments. The cage can also include a cage segment including an inventive flange and a cage segment without an inventive flange. Likewise bearing cages formed one-piece can also have a complete flange or a partial flange.

A further aspect of the present disclosure relates to rolling-element bearings, in particular tapered roller bearings including an outer ring and an inner ring, between which rolling elements are disposed, which are received in a bearing cage as disclosed and described herein.

Further advantages and advantageous embodiments are defined in the dependent claims, the description, and the drawings.

In the following the disclosure is described in more detail with reference to the exemplary embodiments depicted in the drawings. Here the exemplary embodiments are purely exemplary in nature and are not intended to establish the scope of the invention. This scope is defined solely by the appended claims.

### BRIEF DESCRIPTION OF THE DRAWINGS

FIG. 1 is a schematic sectional view through a rolling-element bearing according to the present disclosure.

FIG. 2 is a schematic perspective view of a first exemplary embodiment of a bearing cage according to the present disclosure.

FIG. 3 is a second schematic perspective view of a second advantageous exemplary embodiment of the disclosed bearing cage.

### DETAILED DESCRIPTION

In the following, identical or functionally equivalent elements are designated by the same reference numerals.

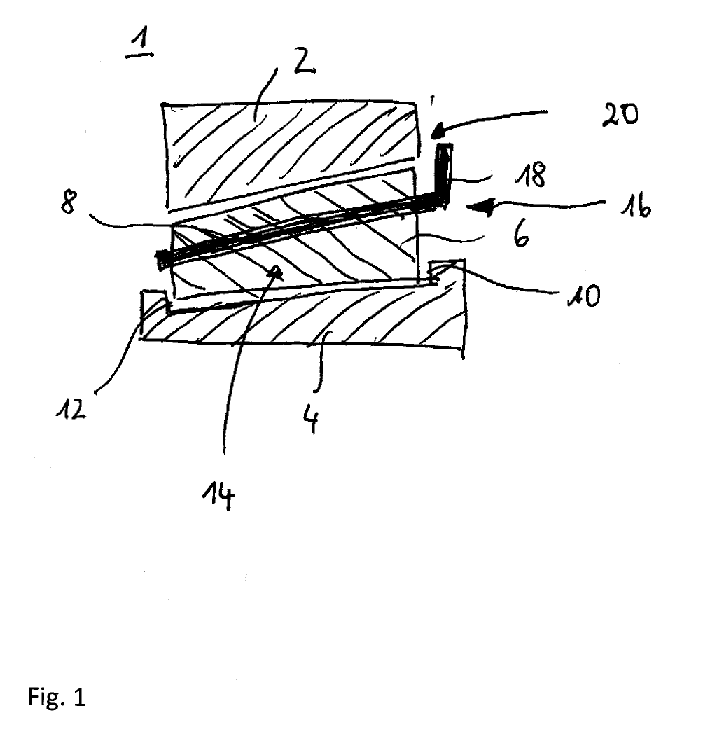

FIG. 1 shows a schematic sectional view through a rolling-element bearing 1 that is formed as a tapered roller bearing. As can be seen in FIG. 1, the tapered roller bearing 1 includes a bearing outer ring 2 and a bearing inner ring 4, and a plurality of rolling elements 6 are disposed between the bearing outer ring 2 and the bearing inner ring 4. A retaining flange 12 is formed on the bearing inner ring 4, and a guide flange 10 is formed on the bearing outer ring 2, which flanges help define positions for the rolling elements 6. The rolling elements 6 are received in a bearing cage 8 that axially supports the rolling elements 6 and circumferentially spaces them from one another.

Due to the conical shape of the rolling elements 6, a pumping effect of the lubricant occurs in a direction from the smaller diameter towards the larger diameter. The lubricant is thus pumped from the bearing interior 14 outward into an outer region 16 of the bearing 1 from which it can no longer be guided back onto the rolling element 6 and thus no longer participates in the lubrication process. This can lead to a high degree of wear of the elements of the bearing 1 that move against each other, in particular in the sliding friction region of the guide flange 10, since only an insufficient lubrication can be provided by the remaining amount of lubricant. In addition, lubricant aging is significantly increased because only a small amount of lubricant is actually involved in the lubricating process, and the continual shearing and reuse of this smaller volume of lubricant causes the lubricant to break down and wear out faster. Both factors influence and limit the bearing service life.

As can further be seen in FIG. 1, the bearing cage 8 includes a flange 18 that extends radially outward. Flange 18 helps ensure that the lubricant is held in a defined volume 20 between rolling elements 6, bearing outer ring 2, and flange 18, and from there is further involved in the lubricating process. Due to this lubricant retention by the flange 18 bearing lubrication is improved in the bearing 1, and lubricant aging is also improved overall due to the higher throughput of lubricant.

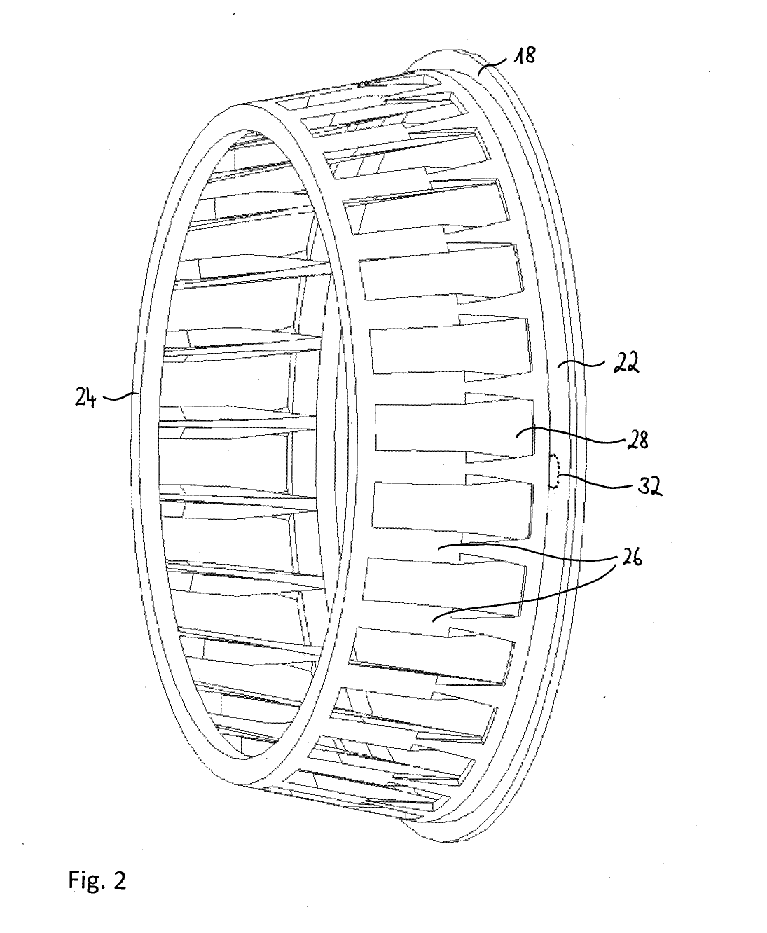

FIG. 2 schematically illustrates a perspective view of such a bearing cage 8 without the inner and outer bearing rings 2, 4. As can be seen in FIG. 2, the bearing cage 8 includes a first ring element 22 and a second ring element 24, and the first ring element 22 has a larger diameter than the second ring element 24. The two ring elements 22, 24 are connected to each other via bridges 26. Pockets 28 are formed between the bridges 26, which pockets 28 are designed to receive the rolling elements and keep them spaced from one another.

The dashed lines in FIG. 2 show that a recess or opening 32 can optionally be provided between the ring element 22 and the flange 18, through which recess 32 the lubricant can be guided back from the cage exterior onto the end side of the rolling element 6.

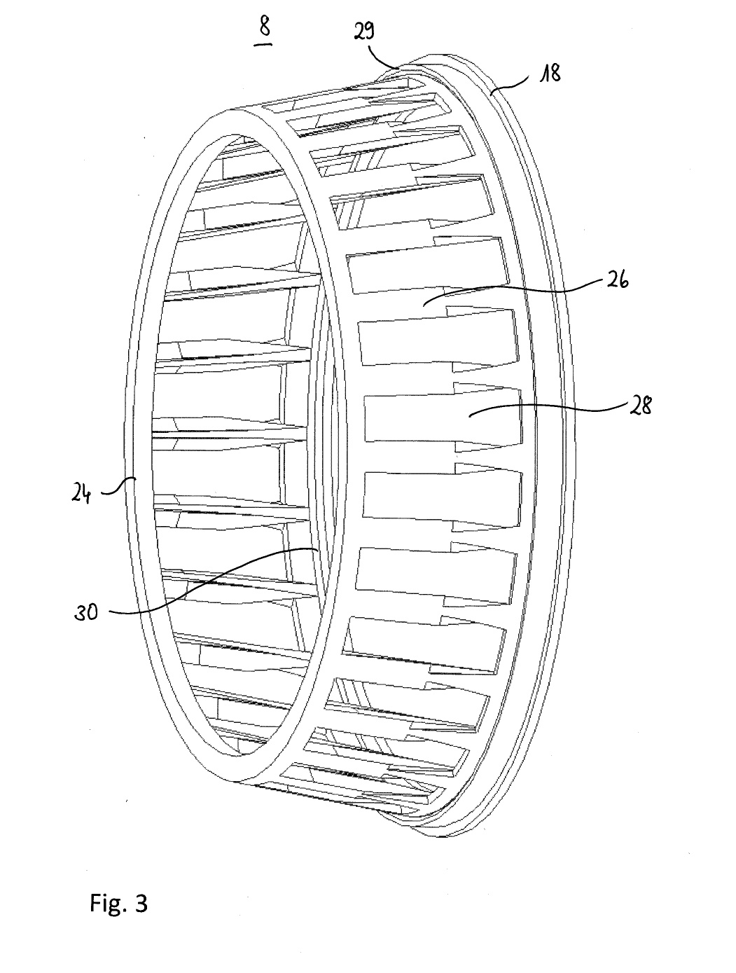

The flange 18 can be formed integrally with the ring element 22; however, it is also possible, as depicted in FIG. 3, to form the flange 18 as a separate element that is placed on the ring element 22 or fixedly connected thereto. This can be effected by an interference-fit connection, for example, clipping-on, or by a materially-bonded connection, such as, for example, welding. This design is particularly advantageous since it allows already existing bearing cages to be equipped with the disclosed flange 18.

With continued reference to FIG. 4, the mounted flange 18 forms a step 29 to the bearing cage 1, in particular to the ring element 22. This step 29 in turn assists with the lubricant retention function of the flange 18. Furthermore, FIG. 2 shows that in addition to the radially outward step 29, a radially inward step 30 may be formed so that a certain degree of lubricant retention is also provided in this location. Of course it is also possible for the flange 18 to extend further inward overall.

Using the disclosed flange 18 lubricant is advantageously prevented from escaping unimpeded in large amounts, from the region of the cage 8 to the static regions. The flange helps retain lubricant that is pumped towards the larger diameter ring so that it can be further used for lubricating the rolling elements 6. This increases the amount of lubricant available for lubrication in the region of the rolling elements which reduces lubricant aging by increased lubricant exchange and helps ensure that sufficient lubricant is provided to the regions to be lubricated, in particular in the region between the flanges 10 and 12 and the rolling elements 6. As a result, wear of the rolling-element bearing 1 can be reduced and its service life can be increased.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing cages.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Rolling-element bearing
2 Bearing outer ring
4 Bearing inner ring
6 Rolling-element bearing
8 Bearing cage
1 Guide flange
12 Retaining flange
14 Bearing inner ring
16 Bearing outer ring
18 Flange
20 Lubricant volume
22 First ring element
24 Second ring element
26 Bearing cage bridge
28 Pocket
29 Radially outer step
30 Radially inner step
32 Recess

We claim:

1. A bearing cage for a tapered rolling-element bearing comprising:
at least one first ring element; and
at least one second ring element connected to the at least one first ring element via at least one bridge,
wherein the at least one first ring element and the at least one second ring element are configured to receive at least one rolling element between them and to retain the at least one rolling element axially,
wherein the at least one bridge is configured to retain the at least one rolling element circumferentially, and
wherein at least the at least one first ring element includes a flange extending at least partially radially outward beyond a radially outer surface of the at least one bridge.

2. The bearing cage according to claim 1, wherein the flange extends radially inward up to a radially inner surface of the at least one bridge.

3. The bearing cage according to claim 1, wherein the flange and the at least one first ring element are formed integral.

4. The bearing cage according to claim 1, wherein the flange and the at least one first ring element are formed separately, and wherein the flange is connected to the at least one first ring in an interference-fit manner.

5. The bearing cage according to claim 1, wherein at least one recess is formed between the flange and the at least one first ring element.

6. The bearing cage according to claim 5, wherein the at least one bridge comprises a first bridge and a second bridge and a pocket between the first bridge and the second bridge and wherein the at least one recess is disposed in a region of the pocket.

7. The bearing cage according to claim 1, wherein the at least one first ring element has a first radius and the at least one second ring element has a second radius, and wherein the first radius is larger than the second radius.

8. The bearing cage according to claim 1, comprising a plurality of bearing cage segments.

9. A tapered rolling-element bearing comprising:
an outer bearing ring;
an inner bearing ring, and
rolling elements disposed between the outer bearing ring and the inner bearing ring; and
a bearing cage according to claim 1,
wherein the rolling elements are mounted between the outer bearing ring and the inner bearing ring in the bearing cage

10. A rolling-element bearing according to claim 9, wherein the flange extends radially outward beyond a radially inner edge of the outer ring.

11. The bearing cage according to claim 1,
wherein the flange extends radially inward up to a radially inner surface of the at least one bridge,
wherein the flange and the at least one first ring element are integrally formed,
wherein at least one opening is formed between the flange and the at least one first ring element,
wherein the at least one bridge comprises a first bridge and a second bridge and a pocket between the first bridge and the second bridge and wherein the at least one recess is disposed in a region of the pocket, and
wherein the at least one first ring element has a first radius and the at least one second ring element has a second radius different than the first radius.

12. A bearing cage for a tapered rolling-element bearing comprising:
a first ring element having a first radius; and
a second ring element connected to the first ring element via a first bridge and a second bridge, the second ring element having a second radius smaller than the first radius,
wherein the first ring element and the second ring element and the first bridge and the second bridge define a pocket configured to receive and retain a rolling element, and
a flange extending radially outward from the first ring element, the flange extending beyond an outer surface of the first bridge.

13. The bearing cage according to claim 12, wherein the flange extends radially inward up to a radially inner surface of the first bridge.

14. The bearing cage according to claim 12, wherein the flange and the first ring element are integral.

15. The bearing cage according to claim 12, wherein the flange and the first ring element are formed separately, and wherein the flange is connected to the at first ring in an interference-fit manner.

16. The bearing cage according to claim 12, including an opening between the flange and the at least one first ring element.

17. A tapered rolling-element bearing comprising:
an outer bearing ring;
an inner bearing ring, and
rolling elements disposed between the outer bearing ring and the inner bearing ring; and
a bearing cage according to claim 12,
wherein the rolling elements are mounted between the outer bearing ring and the inner bearing ring in the bearing cage

18. A rolling-element bearing according to claim 17, wherein the flange extends radially outward beyond a radially inner edge of the outer ring.
